(19) United States
(12) Patent Application Publication
(10) Pub. No.: US 2007/0232396 A1
(43) Pub. Date: Oct. 4, 2007

(54) Online Game Service System For Randomly Allocating Game Channels According To User Behavior Patterns And Method Thereof

(75) Inventor: Won-Seok Yoo, Seoul (KR)

Correspondence Address: BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 10/599,637

(22) PCT Filed: Apr. 8, 2005
(86) PCT No.: PCT/KR05/01014

§ 371 Date: Oct. 4, 2006

(30) Foreign Application Priority Data
Apr. 8, 2004 (KR) 10-2004-0024100

(51) Int. Cl. G06F 17/00

(52) U.S. Cl. 463/42

(57) ABSTRACT

An online game service system for randomly allocating game channels according to user behavior patterns includes a user behavior pattern database, a channel database, a channel server, and a game server so that users having the same or similar game behavior patterns may play games. The user behavior pattern database stores behavior pattern classification references and user game behavior patterns. The channel database stores a list of random channels and data on game rooms at the random channels. The channel server selects a random channel according to the user behavior pattern, provides data on game rooms generated in the selected random channel, and controls a user to enter a game room. The game server provides a game service to the users having entered game rooms, determines game behavior patterns of the users by using behavior pattern references, and stores the determined game behavior patterns in the user behavior pattern database.

### TECHNICAL FIELD

The present invention relates to a game service for servicing a game through the Internet. More specifically, the present invention relates to an Internet game service system and method for randomly allocating game channels according to users' behavior patterns.

### BACKGROUND ART

Various categories of services have been provided through the medium of the Internet as the use of the Internet has increased. In particular, many Internet users enjoy game services on the Internet, and hence, many service providers provide various games to the users. Games in which game points are given or taken between the gamers for the sake of winning or losing the game are currently being offered. For example, the Korean traditional Go-Stop game such as Mat-Go with a 1:1 match and poker are popular Internet card games.

When attempting to perform a desired game through the game service, the user accesses a corresponding game service server and selects the desired game through web pages provided by the server. The corresponding server then displays a channel list for using the game to the user, and displays a list of game rooms belonging to the selected game when selecting a specific channel. The corresponding server displays a game screen so that the user may perform a game with another gamer in a game room selected or generated by the user when the user selects one of game rooms displayed on the user's computer or directly generates a new game room.

In general, the users must perform the above-descried process to enjoy the game on the Internet, and malicious users familiar with each other plot together to enter a specific game room and play the game in collusion, thereby damaging the chances of the compliant users, when the compliant users enter a specific game room and perform the game.

Also, expert or experienced gamers sometimes desire to play the game together with other experienced gamers. Therefore, Internet game services for satisfying the users' requirements are needed.

### DISCLOSURE

### Technical Problem

It is an advantage of the present invention to provide an Internet game service system and method for randomly allocating game channels according to users' behavior patterns so that users with similar game behavior patterns may gather at the same channel and play the game through classification of the users' game patterns.

It is another advantage of the present invention to provide an Internet game service system and method for randomly allocating game channels according to users' behavior patterns so that the users may be identified to be malicious users and compliant users and the compliant users may be prevented from playing the game with the malicious users.

### Technical Solution

In one aspect of the present invention, in a system for providing a game service to a plurality of users connected to the Internet, an Internet game service system comprises: a user behavior pattern database for storing a plurality of behavior pattern classification references for classifying user behavior patterns per game and game behavior pattern information on the users; a channel database for storing a list of per-game random channels and data on game rooms generated at the random channels; a channel server for selecting one of the random channels in the channel database according to the respective users' behavior pattern information according to the user behavior pattern database, providing data on game rooms generated in the selected random channel, and controlling a user to enter a selected game room when the user selects the game room; and a game server for providing a game service to the users who have entered respective game rooms by the channel server, determining game behavior patterns of the respective users who play the game by using behavior pattern references stored in the user behavior pattern database, and storing the determined game behavior patterns in the user behavior pattern database.

In another aspect of the present invention, in a method for providing a game service to a plurality of users connected to the Internet, an Internet game service method comprises: a) determining a user's game behavior pattern for the game selected by the user; b) selecting a specific random channel according to the determined game behavior pattern of the user (where the random channel cannot be directly selected by the user); c) displaying game rooms in the selected specific random channel to the user and controlling the user to select one of the game rooms; and d) controlling users to play the game in the game room at the specific random channel selected by the user, and concurrently analyzing and recording game behavior patterns of the users who play the game.

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

FIG. 1 shows a block diagram of an Internet game service system for randomly allocating game channels according to users' behavior patterns according to an exemplary embodiment of the present invention.

As shown in FIG. 1, the Internet game service system for randomly allocating game channels according to users' behavior patterns includes a web server 100, a channel/random channel database 200, a user behavior pattern database 300, a channel server 400, a game database 500, and a game server 600.

The web server 100 provides a plurality of services including a chat service, a community service, and a shopping mall service in addition to various Internet games including a Go-Stop card game and poker to a plurality of user computers 700-1 to 700-n accessed through the Internet 800. As shown, the users utilize computers 700-1 to 700-n, and other types of terminals to access the web server 100 through the Internet 800 and play a game are available. Terminals may include mobile terminals and Internet TVs which may also be available to the users.

The channel/random channel database 200 stores data on general channels and random channels for each game and data on game rooms generated at the general channels and the random channels. In this instance, the general game channel is selected and can be entered by a user, and the random channel is not selected by the user but is automatically randomly selected according to the user's game behavior pattern when the user has an intention to enter a game room through the random channel. Here, the random channel has been described to be randomly selected, which does not represent that a predefined random channel is given from among a plurality of random channels but which indicates that a random channel determined by the classification of the user's game behavior pattern can be selected.

The user behavior pattern database 300 classifies the respective users' behavior features when playing the game and stores them according to users. The classified users' game behavior patterns include a classification of malicious users who play the game with other users in collusion and compliant users, a classification following game usage, and a classification depending on bets, according to features of the game.

The channel server 400 refers to the channel/random channel database 200 and provides a general channel and a random channel of a selected game and a game room list for each general channel when the user selects the game through the web server 100. In this instance, as to the random channel, no random channel list is displayed but a display for a selection on the entrance through the random channel is provided, and when the user selects the display, the channel server 400 refers to the user behavior pattern database 300 to select a random channel and allow the user to enter therethrough and then displays a game room list of the corresponding random channel to the user. Therefore, other users having game behavior patterns similar to those of the user are allowed to enter the random channel selected by the channel server 400.

The user can select a channel for playing the game and a specific game room belonging to the channel through a general channel list and a game room list provided by the channel server 400, and the user can also enter the random channel through which the users having the game behavior patterns similar to those of the user have entered and select a specific game room belonging to the random channel. In this instance, when the user selects a game through the web server 100, the web server 100 initiates a user program for the game pre-installed in the user computer 700-1 to 700-n, and the user computer 700-1 to 700-n accesses the channel server 400 through the Internet 800 by the user program, and hence, it is not needed to directly couple the channel server 400 to the web server 100. Therefore, the web server 100 is coupled to other components if necessary by the user, which is depicted by dotted lines in FIG. 1.

Also, the channel server 400 allows new users to enter the corresponding game room while the users play the game, and the new users stand by for the game as observers.

The game database 500 stores game logic for controlling the game progress.

The game server 600 provides a game service selected by the user through the channel server 400. That is, the game server 600 refers to the game database 500 to execute the game according to game logic established for each game. For example, when the user selects poker, generates or selects a specific game room on a specific channel through the channel server 400, and at least two users enter the poker game, the game server 600 displays the game, executes the game, and settles game results so that the users may play poker.

In this instance, the game logic represents specified rules for automatically performing the game according to a predefined rule. For example, poker has a rule for distributing cards, a rule for selecting one of three cards after distribution, a rule for placing a bet, and a rule for achieved results on various games.

The game server 600 monitors the users who have entered each game room while the users play the game, and classifies the corresponding users' game behavior patterns and stores the same in the user behavior pattern database 300 when the game is over. As previously described, the classified users' game behavior patterns include a classification of malicious users and compliant users, a classification following game usage, and a classification depending on bets, according to features of the game. The game server 600 determines to which classification each gamer's game behavior pattern belongs and stores the game behavior pattern in the user behavior pattern database 300. In particular, it is needed in the above-noted classifications to accurately identify malicious users and compliant users so that the compliant users may not be damaged by the malicious users.

Therefore, the game server 600 is to accurately analyze the gamers' game behavior patterns and accurately identify malicious users and compliant users. To achieve this, the game server 600 has a reference rule for detecting and classifying malicious users, and classifies the users, for example based on the channels in the first place. In general, the malicious users tend to play the game in a game room of an intermediate channel, and in particular, an advanced specific channel, and a full betting channel in the case of poker, which can be used as channel references. Second, the users can be classified with reference to bet patterns. For example, three to four users in a group wait for a compliant user and only bet seed money so as to save cost in the game room for poker, and make a full bet and control one of the malicious users to win the game and take the total bets in collusion when the compliant user enters the game room, which can also be a reference of bet patterns. Therefore, the malicious users play the game with the minimum bet or without a bet except the initial bet in most cases until the compliant users enter the game room, and hence, the subsequent math figure is applicable.
Winner's taken money=[Seed money×(the number of gamers−1)]−dealer fee

where the seed money represents predefined money provided by all the users for progressing a game, and the dealer fee indicates money given to the game server 600 from the total bet when the game server 600 has progressed the game. In this instance, the dealer fee may not be generated according to the game server 600 or a category of the game. In addition to the above-noted references, other various references for identifying the malicious users and the compliant users can be provided.

In the exemplary embodiment, the malicious users are finally classified by combining the first and second references. For example, when users play the game in a game room of a specific channel (e.g., a full bet game room) and the number of played games is greater than 100 which is considered to be malicious users according to the second reference, or when users play the game in a full bet game room and the percentage of the number of played games by malicious users according to the second reference with respect to the total number of played games is greater than 50%, the corresponding users are finally classified as malicious users.

In addition to the above-noted classifications, the users can be classified by various levels according to game usage. For example, a user may have a full bet at the fifth card and another user may have a full bet at the fourth card in the poker game. The above-noted bets can be references for classifying the users.

FIG. 2 shows a detailed block diagram of the channel/random channel database 200 shown in FIG. 1.

As shown in FIG. 2, the channel/random channel database 200 includes general channels 210-1 to 210-m which the users can select and enter and random channels 220-1 to 220-n which allows the users who have similar game behavior patterns according to classified user behavior patterns to automatically enter.

The random channels 220-1 to 220-n are not specified by the user behavior patterns. Users enter the random channel by the channel server 400 irrespective of the user behavior patterns in the initial stage, and when a user with a specific behavior pattern has already entered a specific random channel, users who have similar or same game behavior patterns can enter the random channel.

FIG. 3 shows a detailed block diagram of the user behavior pattern database 300 shown in FIG. 1.

As shown in FIG. 3, the user behavior pattern database 300 includes a user behavior pattern reference database 310 and a user behavior pattern information database 320.

The user behavior pattern reference database 310 stores various user behavior pattern references for classifying the users' game behavior patterns, including a reference for classifying the malicious users and compliant users, a classification reference according to game usage, and a classification reference according to bet degrees.

The user behavior pattern information database 320 stores the users' behavior pattern classification information.

FIG. 4 shows a detailed block diagram of the channel server 400 shown in FIG. 1.

As shown in FIG. 4, the channel server 400 includes a channel display unit 410, a random channel controller 420, a game room display 430, and a channel controller 440.

The channel display unit 410 refers to the channel/random channel database 200 and displays a list of general channels which the user having selected the game can select and enter and a channel display for entering the random channel to the user through the user computer 700-1 to 700-n.

The random channel controller 420 controls to select and enter one of the random channels 220-1 to 220-n in the channel/random channel database 200 according to the corresponding user's behavior pattern when the user selects to enter the random channel through the channel display unit 410.

In detail, the random channel controller 420 includes a user behavior pattern determiner 421 and a random channel determiner 423.

The user behavior pattern determiner 421 determines the game behavior pattern classification of the user having selected the random channel by referring to the user behavior pattern information database 320 of the user behavior pattern database 300.

The random channel determiner 423 determines a random channel that the corresponding user will enter from among the random channels 220-1 to 220-n in the channel/random channel database 200 based on the user's behavior pattern classification determined by the user behavior pattern determiner 421. In this instance, the random channel determiner 423 controls the corresponding user to enter an empty random channel or randomly selects one of the random channels that the users having game behavior patterns that are the same or similar to that of the corresponding user have entered and controls the corresponding user to enter the random channel. For example, when the game behavior pattern of the user having selected the entrance to the random channel is classified to be a compliant user, the random channel determiner 423 controls the user to enter an empty random channel or selects one of the random channels that the compliant users have entered and controls the corresponding user to enter the random channel. Accordingly, the users with the same or similar game behavior patterns gather and play the game. For example, when the compliant users are controlled to play the game together with other compliant users, the compliant users may not be damaged by the malicious users.

Next, when a general channel is selected by the channel display unit 410 or a random channel is determined by the random channel controller 420, the game room display 430 refers to the channel/random channel database 200 and displays a list of game rooms in the corresponding general channel/random channel to the user through the user computer 700-1 to 700-n.

The channel controller 440 controls the channel display unit 410, the random channel controller 420, and the game room display 430 so that the user may enter a general channel or a random channel, select a game room in the corresponding channel, and enter the game room.

FIG. 5 shows a detailed block diagram of the game server 600 shown in FIG. 1.

As shown in FIG. 5, the game server 600 includes a user behavior pattern monitor 610, a user behavior pattern determiner 620, a user behavior pattern recorder 630, and a game controller 640.

The user behavior pattern monitor 610 refers to the respective behavior pattern references in the user behavior pattern reference database 310 of the user behavior pattern database 300 and monitors the users' behavior patterns on playing the game.

The user behavior pattern determiner 620 uses game behavior pattern information of the users monitored by the user behavior pattern monitor 610 and finally determines the respective users' game behavior patterns while the users are playing the game or when they finished playing the game.

The user behavior pattern recorder 630 stores the respective users' game behavior patterns determined by the user behavior pattern determiner 620 in the user behavior pattern information database 320.

The game controller 640 refers to the game database 500 to find game rules and controls the progress of game so that the users may play the game, and further controls to record the respective users' game behavior patterns determined by the user behavior pattern monitor 610 and the user behavior pattern determiner 620 in the user behavior pattern information database 320 through the user behavior pattern recorder 630 while the users are playing the game or when they finished playing the game.

Referring to FIG. 6, an Internet game service method for randomly allocating a game channel according to users' behavior patterns according to an exemplary embodiment of the present invention will be described in detail. It is assumed before description that information on the respective users' game behavior patterns is pre-stored in the user behavior pattern information database 320, and the process for storing the information on the users' game behavior patterns in the user behavior pattern information database 320 will be described later.

A plurality of users use their computers 700-1 to 700-n to execute a user program provided by the web server 100 or directly access the channel server 400 or uses a web browser to directly access the web server 100, and selects a desired game in step S100. In this instance, the user program is described to have been preinstalled, and in another case, the web server 100 or the channel server 400 controls and determines when to install the user program for the corresponding game at an appropriate time.

When the game is selected by the user, the channel controller 440 of the channel server 400 displays a per-game general channel list and a random channel entrance display stored through the channel display unit 410 in the channel/random channel database 200 to the user computers 700-1 to 700-n through the web server 100 in step S110, and the user selects an entrance to a general channel or a random channel for playing the game from among the general channel and random channel entrance displays displayed on the computer 700-1 to 700-n. For example, when the general channel list is displayed by grades, the user can select a channel depending on the user's grade. Also, the user selects a random channel so as to play the game with other users having game behavior patterns that are the same as or similar to that of the user. For example, the user can select a random channel so as to prevent being damaged by malicious users.

When a general channel is selected by the user in step S120, the channel server 400 displays a list of game rooms generated to the corresponding channel stored in the channel/random channel database 200 to the user computer 700-1 to 700-n through the game room display 430 in step S150, and the user selects and enters one of the game rooms displayed on the user's computer 700-1 to 700-n in step S160.

However, when the user selects an entrance to a random channel in step S120, the channel server 400 takes game behavior pattern information of the corresponding user in the user behavior pattern information database 320 through the user behavior pattern determiner 421 of the random channel controller 420 in step S1 30, and determines one of the random channels 220-1 to 220-n in the channel/random channel database 200 through the random channel determiner 423 in step S140. The random channel determiner 423 selects a random channel according to the user's game behavior pattern, and in detail, randomly determines one of the random channels when the random channels with the same or similar game behavior patterns are provided, and determines one of empty random channels when no such random channels with the same or similar game behavior patterns are provided.

When a specific random channel is selected by the random channel controller 420, the channel server 400 displays a list of game rooms generated to the corresponding random channel stored in the channel/random channel database 200 to the user computer 700-1 to 700-n through the game room display 430 in step S150, and the user selects and enters one of the game rooms displayed on the user's computer 700-1 to 700-n in step S160.

When the user selects and enters a specific game room in the general channel or a random channel, the game server 600 uses game logic stored in the game database 500 to control the respective users to play the game, and concurrently determines and records the respective users' game behavior patterns in step S170.

The process for recording the game behavior pattern and playing the game in step S170 will now be described with reference to FIGS. 7 and 8.

When the game starts in step S171, the user behavior pattern monitor 610 of the game server 600 refers to the user behavior pattern reference database 310 and monitors the respective users' game behavior patterns such as motion in step S172 and S173 until the game is over.

When the game is over, the user behavior pattern determiner 620 analyzes game behavior patterns of the users monitored by the user behavior pattern monitor 610 in step S174, and determines the respective users' final game behavior patterns in step S175.

The user behavior pattern recorder 630 records and stores the users' game behavior patterns determined by the user behavior pattern determiner 620 in the user behavior pattern information database 320 in step S176.

The process for monitoring the user's game behavior pattern of step S172 will be described for the case of poker with reference to FIG. 8, which will be executed by the user behavior pattern monitor 610.

When a game starts in step S172-1, the bet for each user is recorded each time a card is distributed in step S172-2 and the recording process is continued until the corresponding game is over in step S172-3.

When the corresponding game is over, the total bet for each user is analyzed, the corresponding game is analyzed to which one of the references in the user behavior pattern reference database 310 the corresponding game belongs in step S172-4, and the game behavior pattern is determined. For example, when the total bet and the winner's taken money are analyzed and Math FIG. 1 is satisfied, the users who have progressed the corresponding game satisfy the reference of malicious users. When the number of played games becomes greater than a predetermined number of games or a percentage with respect to the total games becomes greater than a predetermined percentage in the process for analyzing and determining the user behavior pattern of steps S174 and S175, the corresponding users are finally classified as malicious users and are recorded and stored in the user behavior pattern information database 320, and when they enter random channels, the random channels where only the malicious users gather will be selected by the channel server 400.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

For example, the channel server 400 can control the users to select and enter a random channel not by using a fixed user game behavior pattern but by using game behavior pattern information that is different from that of the corresponding users used for determining the random channel when the corresponding users enter the random channel.

Also, it has been described that the channel server 400 extracts the respective users' game behavior patterns from the user behavior pattern database 320 and uses the same, and it is also possible without being restricted to this for a web server or an additional log-in server to extract user behavior pattern information and transmit the same to the channel server 400 in the log-in process which is essential to the users when they directly access the channel server 400 through the web server 100 or the user program.

### Advantageous Effects

According to the present invention, users maintain excitement for the game by controlling users who have the same or similar game patterns to gather together and play the game according to the respective users' game behavior patterns.

Further, compliant users are encouraged to be continuously excited with the corresponding game since the compliant users need not play the game with malicious users at the same channel.

### DESCRIPTION OF DRAWINGS

FIG. 1 shows a block diagram of an Internet game service system for randomly allocating game channels according to users' behavior patterns according to an exemplary embodiment of the present invention;

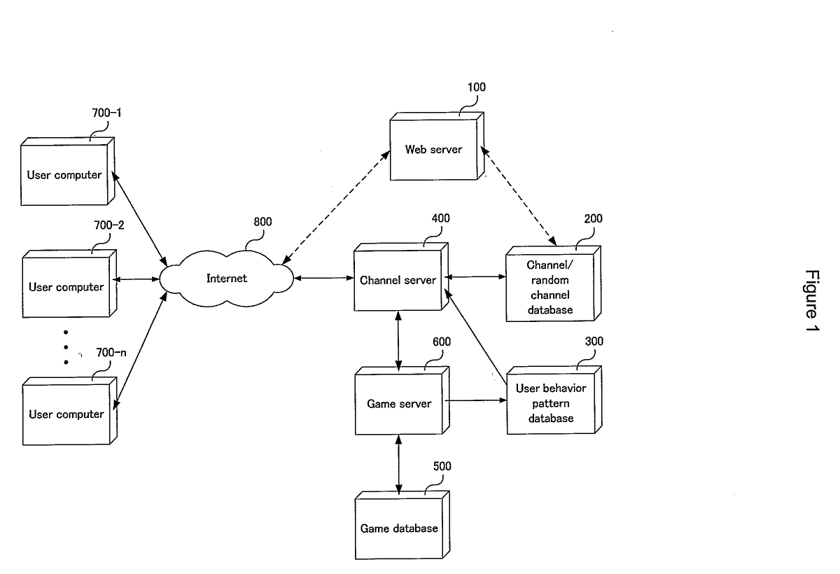

FIG. 2 shows a detailed block diagram of a channel/random channel database shown in FIG. 1;

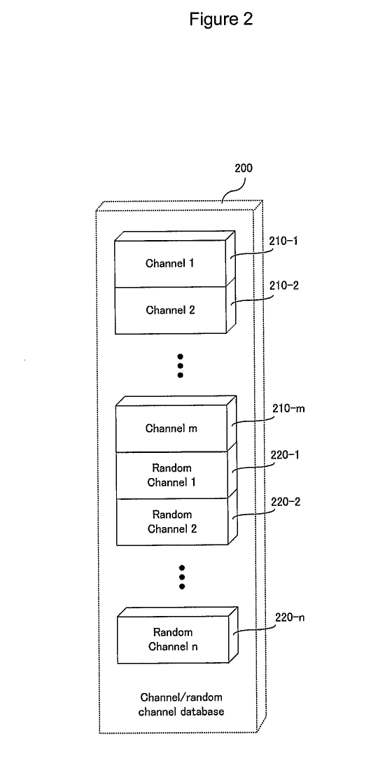

FIG. 3 shows a detailed block diagram of a user behavior pattern database shown in FIG. 1;

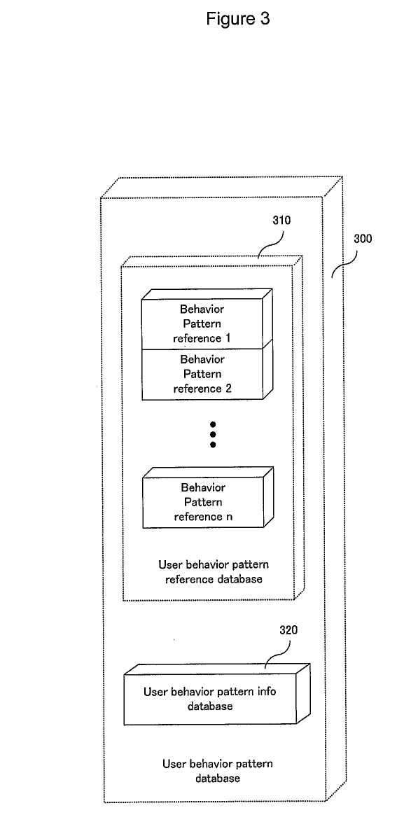

FIG. 4 shows a detailed block diagram of a channel server shown in FIG. 1;

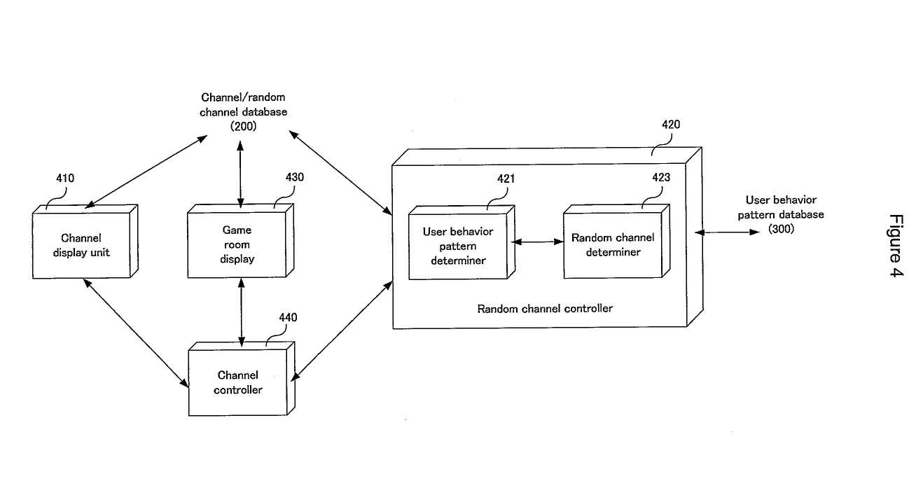

FIG. 5 shows a detailed block diagram of a game server shown in FIG. 1;

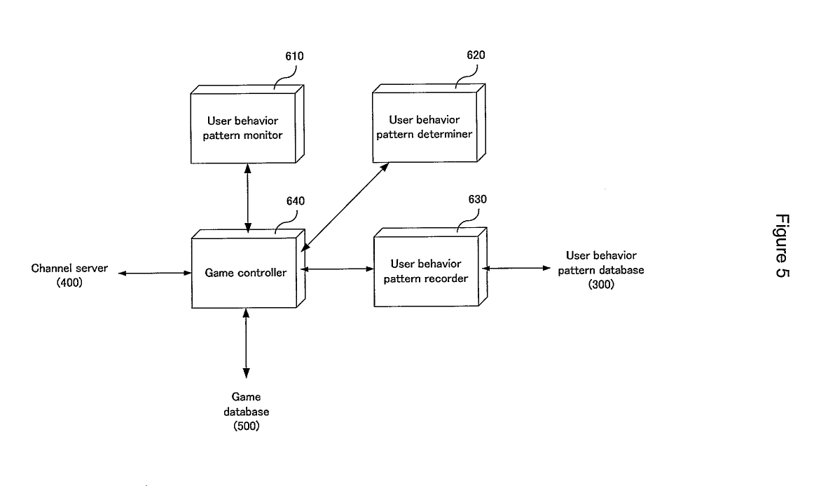

FIG. 6 shows a flowchart of an Internet game service method for randomly allocating game channels according to users' behavior patterns according to an exemplary embodiment of the present invention;

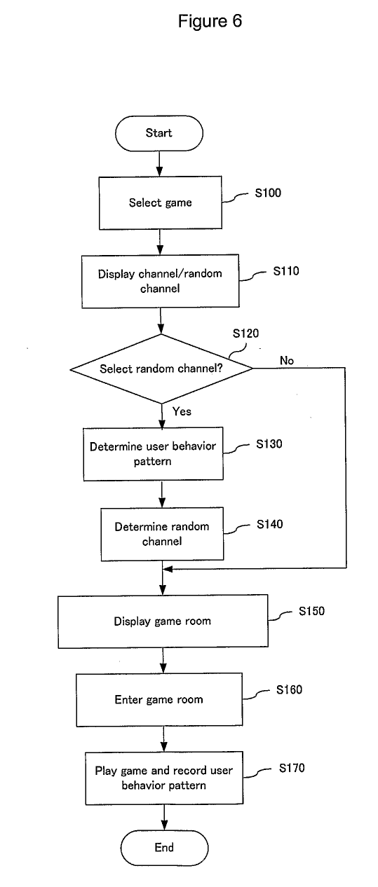

FIG. 7 shows a detailed flowchart of a process for recording users' game behavior patterns while the game is played in the Internet game service method shown in FIG. 6; and

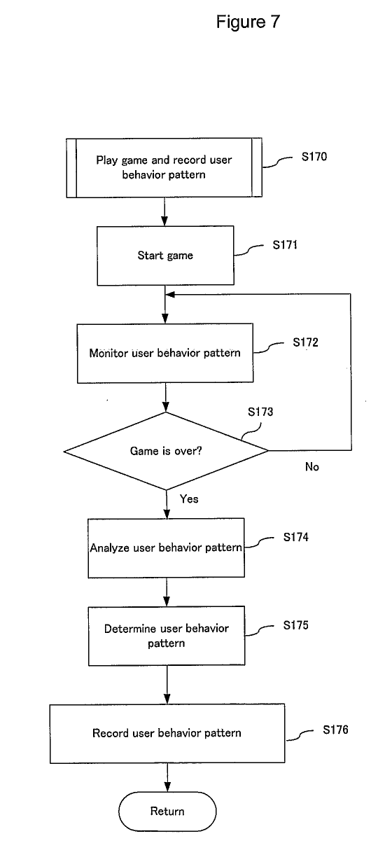

FIG. 8 shows a flowchart of a process for monitoring users' behavior patterns during the process for recording the users' game behavior patterns shown in FIG. 7.

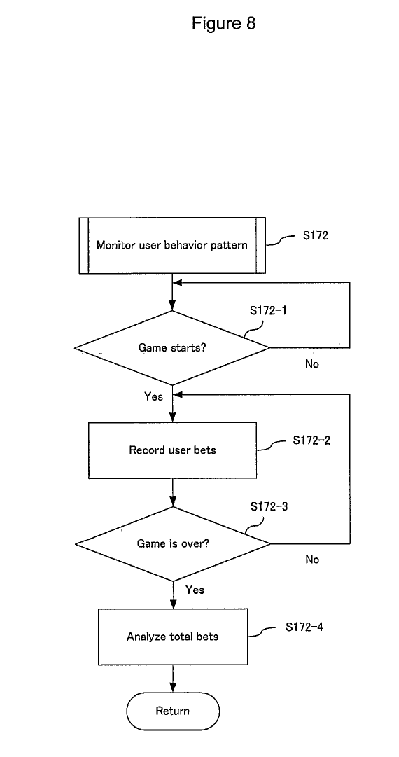

What is claimed is:

1. In a system for providing a game service to a plurality of users, an online game service system comprising:
a user behavior pattern database, the user behavior pattern database storing at least one behavior pattern classification reference for classifying user behavior patterns and game behavior pattern information of the users;
a channel database, the channel database storing random channels for at least one game and data on game rooms generated at the random channels;
a channel server, the channel server selecting one of the random channels in the channel database according to the respective users' game behavior pattern information stored in the user behavior pattern database, the channel server providing data on game rooms generated in the selected random channel, and the channel server controlling access to a selected game room when the user selects the game room; and
a game server, the game server providing a game service to the users who have entered respective game rooms by the channel server, the game server determining game behavior patterns of the respective users who play the game by using the at least one behavior pattern reference stored in the user behavior pattern database, and the game server storing the determined game behavior patterns in the user behavior pattern database.

2. The online game service system of claim 1, wherein the user behavior pattern database comprises:
a user behavior pattern reference database for storing the at least one behavior pattern classification references for classifying game behavior patterns; and
a user behavior pattern information database for storing the behavior pattern classification information for respective users.

3. The online game service system of claim 1 2, wherein the channel server controls access to the random channel for the users who have the same or similar game behavior patterns.

4. The online game service system of claim 1, wherein the users' game behavior pattern references include at least one of a classification of collaborative users for deceit and compliant users, a classification in association with game usage, and a classification in association with bets.

5. The online game service system of claim 4, wherein in the classification of collaborative users for deceit and compliant users, a reference for classifying the collaborative users for deceit in the case of a game with bets includes:
a channel reference active at a specific channel; and
a bet reference without bets when no compliant users are provided.

6. (canceled)

7. (canceled)

8. The online game service system of claim 1, wherein the channel database further stores a list of general channels for each channel and data on game rooms generated at the general channel, and
the channel server refers to the channel database and provides data on the general channel for each channel and game rooms generated at the general channel, and controls the user to play the game through the game server in the selected game room when the user selects a specific game room in the general channel.

9. The online game service system of claim 1, wherein the channel server comprises:
a channel displaying component, the channel displaying component displaying a channel display for entrance to a random channel to the user by referring to the channel database;
a random channel controller, the random channel controller controlling the user to select and enter one of the random channels in the channel database according to the corresponding user's game behavior pattern stored in the user behavior pattern database when the entrance to the random channel is selected through the channel displaying component;
a game room displaying component, the game room displaying component displaying a list of game rooms in a determined random channel to the user by referring to the channel database when the random channel is determined by the random channel controller; and
a channel controller, the channel controller controlling the user to enter the random channel and select and enter a game room in the corresponding channel by controlling the channel displaying component, the random channel controller, and the game room displaying component.

10. The online game service system of claim 9, wherein the random channel controller comprises:
a user behavior pattern determination module, the user behavior pattern determination module determining a game behavior pattern classification of the user having selected the random channel by referring to the user behavior pattern database; and
a channel determination module, the channel determination module determining a random channel that the corresponding user will enter from among the random channels in the channel database based on the users' behavior pattern classifications determined by the user behavior pattern determination module.

11. The online game service system of claim 1, wherein the Internet game service system comprises:
a user behavior pattern monitoring module, for the user behavior pattern monitoring mule monitoring the users' behavior patterns of playing the game by referring to the respective behavior pattern references in the user behavior pattern database;
a user behavior pattern determination module, the user behavior pattern determination module finally determining the respective users' behavior patterns of playing the game by using game behavior pattern information of the users monitored by the user behavior pattern monitor while the users play the game or when the game is over;
a user behavior pattern recording module, the user behavior pattern recording module storing the respective users' behavior patterns of playing the game determined by the user behavior pattern determination module in the user behavior pattern database for the respective users; and
a game controller, the game controller controlling the progress of the game by referring to a game rule established for each game so that the users may play the game, and controlling the respective users' behavior patterns of playing the game determined by the user behavior pattern monitor and the user behavior pattern determination module to be recorded in the user behavior pattern database through the user behavior pattern recording module while the users play the game or when the game is over.

12. In a method for providing a game service to a plurality of users, an online game service method comprising:
a) determining a user's game behavior pattern for the game selected by the user;
b) selecting a specific random channel according to the determined game behavior pattern of the user (where the random channel cannot be directly selected by the user);
c) displaying game rooms in the selected specific random channel to the user and controlling the user to select one of the game rooms; and
d) controlling users to play the game in the game room at the specific random channel selected by the user, and concurrently analyzing and recording game behavior patterns of users who play the game.

13. The online game service method of claim 12, further comprising:
displaying a list of general channels for the game selected by the user and an entrance to the random channel; and
receiving the user's game behavior pattern from a storage unit storing users' game behavior patterns when a display for the entrance to the random channel is selected by the user.

14. The online game service method of claim 12, wherein the step b) comprises selecting the random channel so that the users who have the same or similar game behavior patterns may enter the same random channel.

15. The online game service method of claim 14, wherein an empty random channel is selected when no random channel that the users who have the same or similar game behavior patterns have entered is provided.

16. The online game service method of claim 14, wherein one of random channels is automatically randomly selected when a plurality of random channels that the users who have the same or similar game behavior patterns have entered are provided.

17. The online game service method of claim 14, wherein game behavior pattern information other than the user's game behavior pattern information used when the user have entered the random channel is used when the random channel for the user is selected.

18. The online game service method of claim 16, wherein the step d) comprises:
i) monitoring the users' game behavior patterns while the game is played;
ii) analyzing the users' game behavior patterns according to the monitored results when the game is over;
iii) determining the users' game behavior patterns according to the analysis results; and
iv) recording the determined users' game behavior patterns for the respective users.

19. The online game service method of claim 18, wherein when the game has a bet, the step i) comprises:
recording the respective users' bets during each game;
analyzing the respective users' total bets after each game is over; and
determining the respective users' game behavior patterns according to the analysis results.

20. In a method for providing a game service to a plurality of users, an online game service method comprising:
a) determining a user's game behavior pattern for a game selected by the user;
b) selecting a specific random channel according to the determined user's game behavior pattern (where the random channel cannot be directly selected by the user);
c) displaying game rooms in the selected specific random channel to the user and controlling the user to select one of the game rooms; and
d) controlling the users to play the game in the game room at the specific random channel selected by the user, and concurrently analyzing and recording game behavior patterns of the users who play the game,
wherein the users' game behavior pattern references include at least one of a classification of malicious users and compliant users, a classification following game usage, and a classification depending on bets.

21. In a system for providing a game service to a plurality of users via network, an online game service system comprising:
a user behavior pattern database, the user behavior pattern database storing game behavior pattern information of the users;
a channel database, the channel database storing channels for at least one game and data on game rooms generated at the channels;
a channel server, the channel server allocating at least one user's access to game rooms based on the respective user's game behavior pattern information stored in the user behavior pattern database; and
a game server, the game server providing game service to the users who have accessed to the respective game rooms by the channel server.

22. The online game service system of claim 21, wherein the game server determines game behavior patterns of the respective users who have played the game.
